(19) United States
(12) Patent Application Publication
(10) Pub. No.: US 2023/0340239 A1
(43) Pub. Date: Oct. 26, 2023

(54) COLORABLE THERMOPLASTIC POLYMERIC COMPOSITIONS

(71) Applicant: Dow Global Technologies LLC, Midland, MI (US)

(72) Inventors: Chao He, Shanghai (CN); Wenke Miao, Shanghai (CN); Xianmin Xu, Shanghai (CN); Yuming Lai, Midland, MI (US); Mohamed Esseghir, Lawrenceville, NJ (US); Xiaoxiong Miao, Shanghai (CN)

(21) Appl. No.: 18/001,599

(22) PCT Filed: Sep. 29, 2020
(86) PCT No.: PCT/CN2020/118982

§ 371 Date: Dec. 13, 2022

(51) Int. Cl. C08L 23/06; C08K 5/01

(52) U.S. Cl. CPC C08L 23/06; C08K 5/01; C08L 2207/066; C08L 2207/062; C08L 2205/025; C08L 2203/206

(57) ABSTRACT

A polymeric composition includes an ethylene-based polymer and a free radical scavenger having structure (I), wherein, R₁ and R₂ are independently linear, or branch form alkyl, alkenyl, phenyl or aryl group moieties with or without substituents and each of R₁ and R₂ have a carbon number from 1 to 100, further wherein the polymeric composition is thermoplastic.

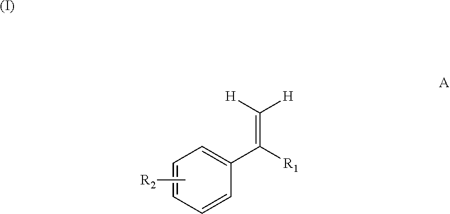

### BACKGROUND

### Field of the Invention

The present disclosure generally relates polymeric compositions and more specifically to colorable polymeric compositions.

### INTRODUCTION

Polymeric jacketing materials are used as an outermost layer of protection for a variety of power and telecommunication cables. The jacketing helps to protect against physical damage the cable may endure during installation and/or use. Jacketing may be colored to help visually distinguish one cable from another. Jacketing installed on cables used outdoors undergo weathering as a result of ultraviolet light in addition to other environmental factors.

Free radicals are generated within the polymeric jacketing during exposure to ultraviolet light (“UV”) and environmental conditions. The free radicals oxidize polymers of the jacketing leading to decreased mechanical properties of the jacketing with increased UV exposure. Various UV weathering standards exist for cables that require a cable to retain a predetermined amount of its tensile strength and tensile elongation at break after a certain accelerated UV testing time period.

A conventional approach to mitigate the effect of free radicals in outdoor or high UV light exposure environments is to include both carbon black and hindered amine light stabilizers (“HALS”). Carbon black, while effective at absorbing ultraviolet light and preventing free radical generation, has a strong effect on the ability to impart a desired color to the jacketing. In addition to carbon black, HALS are utilized in the polymeric jacketing to neutralize free radicals that are generated, but can be deactivated over time. As such, attempts at creating colorable cables through the exclusive use of HALS results in mechanical property degradation over time due to the greater production of free radicals and the eventual deactivation of the HALS.

The use of free radical scavengers other than HALS in polyolefin cable coatings such as a cross-linked insulation layer is known. Free radical scavengers are often used as scorch retarders to delay the onset of crosslinking during polymer extrusion. For example, World Intellectual Property Organization publication number 2019046088A1 (“the '088 publication”) discloses the use of alpha-methyl styrene dimer (“AMSD”) as a radical scavenger for use in peroxide-based crosslinking of polymeric compositions. As used in the '088 publication, the AMSD is employed while the polymer is molten and above the peroxide decomposition temperature such that the polymer may be crosslinked into a thermoset. Similarly, United States patent application publication number 20140079952A highlights the use of diphenyl ethylene, another free radical scavenger, as useful in molten polymer-based systems as a scorch retarder for the formation of thermoset compositions.

In view of the foregoing, it would be unexpected to discover a polymeric composition useful as a jacketing layer that is both colorable and can be used to make a cable that passes UV weathering standards.

### SUMMARY OF THE DISCLOSURE

The present disclosure provides a polymeric composition useful as a jacketing that is both colorable and can be used to make a cable that passes UV weathering standards.

The present disclosure is a result of discovering that the incorporation of a compound comprising structure (I) in polymeric compositions provides UV light resistance to the polymeric composition despite the composition being free of carbon black. Structure (I) is

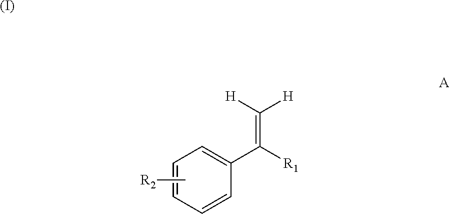

wherein, R₁ and R₂ are independently linear, or branch form alkyl, alkenyl, phenyl or aryl group with or without substituents, with a carbon number range from 1 to 100. The discovery that the incorporation of a compound comprising structure (I) may provide ultraviolet resistance is surprising for at least three reasons. First, the environment structure (I) is used in for UV light resistance in is completely different than the conventional use environment of structure (I). For example, scorch retardant embodiments of structure (I) (i.e., AMSD and diphenyl ethylene) are typically used in molten polymeric environments at temperatures in excess of 100° C. whereas UV resistance environments are solid state and at temperatures ranging from approximately −40° C. to 50° C. Second, the free radicals generated in the conventional crosslinking environment of embodiments of structure (I) have a completely different source than the UV light resistance environment. For example, crosslinking environments typically use one or more peroxides as a free radical generator to initiate crosslinking whereas the UV resistance environment generates free radicals from ultraviolet light impinging on one or more constituents of the polymeric composition. Third, given the demonstrated need to utilize carbon black in addition to a free radical scavenger to provide UV resistance it is surprising that the use of structure (I) without carbon black is able to provide acceptable UV resistance. Given the drastically different use environment (i.e., thermoplastic solid vs. molten crosslinking state) and free radical source, it is surprising that the use of structure (I) allows for the formation of a polymeric composition useful as a jacketing that is both colorable and can be used to make a cable that passes UV weathering standards.

According to a first feature of the present disclosure, a polymeric composition comprises an ethylene-based polymer and a free radical scavenger having structure (I), wherein, R₁ and R₂ are independently linear, or branch form alkyl, alkenyl, phenyl or aryl group moieties with or without substituents and each of R₁ and R₂ have a carbon number from 1 to 100, further wherein the polymeric composition is thermoplastic.

According to a second feature of the present disclosure, the polymeric composition is free of carbon black.

According to a third feature of the present disclosure, the polymeric composition further comprises a colorant.

According to a fourth feature of the present disclosure, the ethylene-based polymer comprises a linear low-density polyethylene having a density of 0.917 g/cc to 0.926 g/cc as measured according to ASTM D792 and a high-density polyethylene having a density of 0.940 g/cc to 0.970 g/cc as measured according to ASTM D792.

According to a fifth feature of the present disclosure, the polymeric composition comprises 80 wt % to 95 wt % high-density polyethylene based on the total weight of the polymeric composition.

According to a sixth feature of the present disclosure, the polymeric composition comprises 5 wt % to 20 wt % of the linear low-density polyethylene based on the total weight of the polymeric composition.

According to a seventh feature of the present disclosure, the free radical scavenger comprises alpha-methyl styrene dimer.

According to an eighth feature of the present disclosure, the free radical scavenger comprises diphenyl ethylene.

According to a ninth feature of the present disclosure, the polymeric composition comprises from 0.1 wt % to 1.0 wt % of the radical scavenger based on a total weight of the polymeric composition.

According to a tenth feature of the present disclosure, a coated conductor comprises a conductor and the polymeric composition disposed at least partially around the conductor.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number.

References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

Melt index (I₂) values herein refer to values determined according to ASTM method D1238 at 190 degrees Celsius (° C.) with 2.16 Kilogram (Kg) mass and are provided in units of grams eluted per ten minutes (“g/10 min”).

Density values herein refer to values determined according to ASTM D792 at 23° C. and are provided in units of grams per cubic centimeter (“g/cc”).

As used herein, Chemical Abstract Services registration numbers (“CAS #”) refer to the unique numeric identifier as most recently assigned as of the priority date of this document to a chemical compound by the Chemical Abstracts Service.

### Polymeric Composition

The polymeric composition of the present invention comprises an ethylene-based polymer, and a free radical scavenger. The polymeric composition is thermoplastic. As used herein, the term “thermoplastic” is used to define a class of polymers that can be softened and melted by the application of heat, and can be processed either in the heat-softened state (e.g. by thermoforming) or in the liquid state (e.g. by extrusion and injection molding).

### Ethylene-Based Polymer

As noted above, one component of the polymeric composition is an ethylene-based polymer. As used herein, “ethylene-based” polymers are polymers in which greater than 50 wt % of the monomers are ethylene though other co-monomers may also be employed. “Polymer” means a macromolecular compound comprising a plurality of monomers of the same or different type which are bonded together, and includes homopolymers and interpolymers. “Interpolymer” means a polymer comprising at least two different monomer types bonded together. Interpolymer includes copolymers (usually employed to refer to polymers prepared from two different monomer types), and polymers prepared from more than two different monomer types (e.g., terpolymers (three different monomer types) and quaterpolymers (four different monomer types)). The ethylene-based polymer can be an ethylene homopolymer. As used herein, “homopolymer” denotes a polymer comprising repeating units derived from a single monomer type, but does not exclude residual amounts of other components used in preparing the homopolymer, such as catalysts, initiators, solvents, and chain transfer agents.

The ethylene-based polymer can have a unimodal or a multimodal molecular weight distribution and can be used alone or in combination with one or more other types of ethylene-based polymers (e.g., a blend of two or more ethylene-based polymers that differ from one another by monomer composition and content, catalytic method of preparation, molecular weight, molecular weight distributions, densities, etc.). If a blend of ethylene-based polymers is employed, the polymers can be blended by any in-reactor or post-reactor process.

The polymeric composition may comprise 90 wt % or greater, or 91 wt % or greater, or 92 wt % or greater, or 93 wt % or greater, or 94 wt % or greater, or 95 wt % or greater, or 96 wt % or greater, or 97 wt % or greater, or 98 wt % or greater, while at the same time, 99 wt % or less, or 98 wt % or less, or 97 wt % or less, or 96 wt % or less, or 95 wt % or less, or 94 wt % or less, or 93 wt % or less, or 92 wt % or less, or 91 wt % or less of the ethylene-based polymer.

The ethylene-based polymer may comprise 50 mol % or greater, 60 mol % or greater, 70 mol % or greater, 80 mol % or greater, 85 mol % or greater, 90 mol % or greater, or 91 mol % or greater, or 92 mol % or greater, or 93 mol % or greater, or 94 mol % or greater, or 95 mol % or greater, or 96 mol % or greater, or 97 mol % or greater, or 97.5 mol % or greater, or 98 mol % or greater, or 99 mol % or greater, while at the same time, 100 mol % or less, 99.5 mol % or less, or 99 mol % or less, or 98 mol % or less, or 97 mol % or less, or 96 mol % or less, or 95 mol % or less, or 94 mol % or less, or 93 mol % or less, or 92 mol % or less, or 91 mol % or less, or 90 mol % or less, or 85 mol % or less, or 80 mol % or less, or 70 mol % or less, or 60 mol % or less of ethylene as measured using Nuclear Magnetic Resonance (NMR) or Fourier-Transform Infrared (FTIR) Spectroscopy. Other units of the ethylene-based polymer may include C₃, or C₄, or C₆, or C₈, or C₁₀, or C₁₂, or C₁₆, or C₁₈, or C₂₀ α-olefins, such as propylene, 1-butene, 1-hexene, 4-methyl-1-pentene, and 1-octene.

The ethylene-based polymer may comprise high-density polyethylene (“HDPE”). HDPE is an ethylene-based polymer having a density of at least 0.940 g/cc, or from at least 0.94 g/cc to 0.97 g/cc. HDPE has a melt index from 0.1 g/10 min. to 25 g/10 min. HDPE can include ethylene and one or more C₃-C₂₀ α-olefin comonomers. The comonomer (s) can be linear or branched. Nonlimiting examples of suitable comonomers include propylene, 1-butene, 1 pentene, 4-methyl-1-pentene, 1-hexene, and 1-octene. HDPE can be prepared with either Ziegler-Natta, chromium-based, constrained geometry or metallocene catalysts in slurry reactors, gas phase reactors or solution reactors. The ethylene/C₃-C₂₀ α-olefin comonomer includes at least 50 wt % ethylene polymerized therein, or at least 70 wt %, or at least 80 wt %, or at least 85 wt %, or at least 90 wt %, or at least 95 wt % ethylene in polymerized form based on the weight of the ethylene-based polymer. In an embodiment, the HDPE is an ethylene/α-olefin copolymer with a density from of 0.9450 g/cc and a melt index of 0.80 g/10 min.

The polymeric composition may comprise 80 wt % or greater, or 81 wt % or greater, or 82 wt % or greater, or 83 wt % or greater, or 84 wt % or greater, or 85 wt % or greater, or 86 wt % or greater, or 87 wt % or greater, or 88 wt % or greater, or 89 wt % or greater, or 90 wt % or greater, or 91 wt % or greater, or 92 wt % or greater, or 93 wt % or greater, or 94 wt % or greater, while at the same time, 95 wt % or less, or 94 wt % or less, or 93 wt % or less, or 92 wt % or less, or 91 wt % or less, or 90 wt % or less, or 89 wt % or less, or 88 wt % or less, or 87 wt % or less, 86 wt % or less, or 85 wt % or less, or 84 wt % or less, or 83 wt % or less, or 82 wt % or less, or 81 wt % or less of HDPE based on the total weight of the polymeric composition.

The ethylene-based polymer may comprise linear low-density polyethylene (“LLDPE”). LLDPE resins are commercially available and may be made by any one of a wide variety of processes including, but not limited to, solution, gas or slurry phase Ziegler-Natta, metallocene or constrained geometry catalyzed (CGC), etc. LLDPEs are ethylene-based polymers having a heterogeneous distribution of comonomer (e.g., α-olefin monomer), and are characterized by the lack of long-chain branching in the resins. LLDPE resins have a density ranging from 0.910 g/cc to 0.926 g/cc. The LLDPE can have a melt index of less than 20 g/10 min., or ranging from 0.1 g/10 min. to 10 g/10 min., or from 2 g/10 min. to 8 g/10 min., or from 4 g/10 min. to 8 g/10 min.

The polymeric composition may comprise 5 wt % or greater, or 6 wt % or greater, or 7 wt % or greater, or 8 wt % or greater, or 9 wt % or greater, or 10 wt % or greater, or 11 wt % or greater, or 12 wt % or greater, or 13 wt % or greater, or 14 wt % or greater, or 15 wt % or greater, or 16 wt % or greater, or 17 wt % or greater, or 18 wt % or greater, or 19 wt % or greater, while at the same time, 20 wt % or less, or 19 wt % or less, or 18 wt % or less, or 17 wt % or less, or 16 wt % or less, or 15 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less or less of LLDPE based on the total weight of the polymeric composition.

### Free Radical Scavenger

The polymeric composition comprises a free radical scavenger having structure (I)

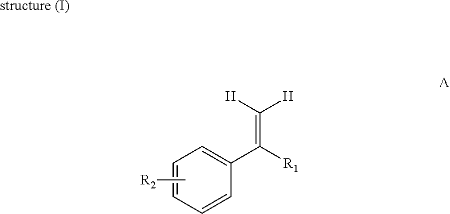

wherein, R₁ and R₂ are independently linear, or branch form alkyl, alkenyl, phenyl or aryl group moieties with or without substituents and each of R₁ and R₂ have a carbon number from 1 to 100. Specific examples of the free radical scavenger include alpha-methyl styrene dimer (CAS #6362-80-7) and diphenyl ethylene (CAS #530-48-3). The free radical scavenger may comprise a single compound described by structure (I) or a mixture of compounds described by structure (I).

The polymeric composition may comprise the free radical scavenger in an amount of from 0.10 wt % to 1.00 wt %. For example, the polymeric composition may comprise 0.010 wt % or greater, or 0.15 wt % or greater, or 0.20 wt % or greater, or 0.25 wt % or greater, or 0.30 wt % or greater, or 0.35 wt % or greater, or 0.40 wt % or greater, or 0.45 wt % or greater, or 0.50 wt % or greater, or 0.55 wt % or greater, or 0.60 wt % or greater, or 0.65 wt % or greater, or 0.70 wt % or greater, or 0.75 wt % or greater, or 0.80 wt % or greater, or 0.85 wt % or greater, or 0.90 wt % or greater, or 0.95 wt % or greater, while at the same time, 1.00 wt % or less, or 0.95 wt % or less, or 0.90 wt % or less, or 0.85 wt % or less, or 0.80 wt % or less, or 0.75 wt % or less, or 0.70 wt % or less, or 0.65 wt % or less, or 0.60 wt % or less, or 0.55 wt % or less, or 0.50 wt % or less, or 0.45 wt % or less, or 0.40 wt % or less, or 0.35 wt % or less, or 0.30 wt % or less, or 0.25 wt % or less, or 0.20 wt % or less, or 0.15 wt % or less of the free radical scavenger.

### Additives

The polymeric composition may comprise additional additives in the form of antioxidants, processing aids, coupling agents, ultraviolet stabilizers (including UV absorbers), antistatic agents, additional nucleating agents, slip agents, lubricants, viscosity control agents, tackifiers, anti-blocking agents, surfactants, extender oils, acid scavengers, flame retardants and metal deactivators. The polymeric composition may comprise from 0.01 wt % to 10 wt % of one or more of the additional additives.

The polymeric composition may be free of carbon black. As used herein, the term “free of” is defined to mean that the formulation comprises less than 0.5 wt % of carbon black based on a total weight of the polymeric composition. As highlighted above, carbon black is effective in absorbing ultraviolet light and preventing free radical generation but has a strong effect on the ability to impart a desired color to the polymeric composition. The inclusion of the free radical scavenger increases the weatherability of the polymeric composition to such a degree that carbon black is not needed and therefore can be eliminated from the polymeric composition.

The polymeric composition may comprise a colorant. As explained above, the absence of carbon black allows the polymeric composition to be colorable by a colorant. The colorant may comprise one or more of an azo dye, an anthraquinone dye and phthalocyanines. The polymeric composition may comprise one or more COLOUR INDEX™ generic name colorants such as Pigment Violet 32 (CAS #12225-08-0), Pigment Orange 34 (CAS #15793-73-4), Pigment Red 38 (CAS #6358-87-8), Pigment Red 208 (CAS #31778-10-6), Pigment Red 48:2 (CAS #7023-61-2), Pigment Red 57:1 (CAS #5281-04-9), Pigment Yellow 155 (CAS #68516-73-4/77465-46-4), Pigment Yellow 151 (CAS #31837-42-0), Pigment Green 7 (CAS #1328-53-6), Pigment Red 122 (CAS #980-26-7/16043-40-6), Pigment Red 214 (CAS #40618-31-3), Pigment Violet 23 (CAS #6358-30-1), and/or Pigment Yellow 191 (CAS #129423-54-7).

The polymeric composition comprises one or more hindered amine light stabilizers. HALS are chemical compounds containing an amine functional group that are used as stabilizers in plastics and polymers. These compounds may be derivatives of tetramethylpiperidine and are primarily used to protect the polymers from the effects of free radical oxidation due to exposure to UV light. The HALS may include one or more of poly(4-hydroxy-2,2,6,6-tetramethyl-1-piperidineethanol-alt-1,4-butanedioic acid) (CAS #65447-77-0); bis(2,2,6,6-tetramethyl-4-piperidyl) sebacate (CAS #52829-07-9); di-(1,2,2,6,6-pentamethyl-4-piperidyl)-2-butyl-2-(3,5-di-tert-butyl-4-hydroxybenzyl)malonate (CAS #63843-89-0); bis(1-octyloxy-2,2,6,6-tetramethyl-4-piperidyl) sebacate (CAS #129757-67-1); poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidyl)imino] (CAS #71878-19-8); 1,3,5-Triazine-2,4,6-triamine, N,N″′-1,2-ethanediylbis[N-[3-[[4,6-bis[butyl(1,2,2,6,6-pentamethyl-4-piperidinyl)amino]-1,3,5-triazin-2-yl]amino]propyl]-N′,N″-dibutyl-N′,N″-bis(1,2,2,6,6-pentamethyl-4-piperidinyl)-(CAS #106990-43-6); 1,6-Hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine (CAS #192268-64-7). Examples of the HALS are commercially available under the tradenames TINUVIN™ 622 and CHIMASSORB™ 944 from BASF, Ludwigshafen, Germany. The polymeric composition may comprise from 0.1 wt % to 1.0 wt % of the HALS based on the total weight of the polymeric composition. For example, the polymeric composition may comprise 0.1 wt % or greater, or 0.2 wt % or greater, or 0.3 wt % or greater, or 0.4 wt % or greater, or 0.5 wt % or greater, or 0.6 wt % or greater, or 0.7 wt % or greater, or 0.8 wt % or greater, or 0.9 wt % or greater, while at the same time, 1.0 wt % or less, or 0.9 wt % or less, or 0.8 wt % or less, or 0.7 wt % or less, or 0.6 wt % or less, or 0.5 wt % or less, or 0.4 wt % or less, or 0.3 wt % or less, or 0.2 wt % or less of the HALS based on the total weight of the polymeric composition.

The polymeric composition can include one or more particulate fillers, such as glass fibers or various mineral fillers including nano-composites. Fillers, especially those with elongated or platelet-shaped particles providing a higher aspect ratio (length/thickness), may improve modulus and post-extrusion shrinkage characteristics. The filler(s) can have a median size or d50 of less than 20 m, less than 10 m, or less than 5 μm. The fillers may be surface treated to facilitate wetting or dispersion in the polymeric composition. Specific examples of suitable fillers include, but are not limited to, calcium carbonate, silica, quartz, fused quartz, talc, mica, clay, kaolin, wollastonite, feldspar, aluminum hydroxide, and graphite. Fillers may be included in the polymeric composition in an amount ranging from 2 to 30 wt %, or from 5 to 30 wt % based on the total weight of the polymeric composition.

The processing aids may comprise metal salts of fluororesin such as polytetrafluoroethylene or Fluorinated ethylene propylene; carboxylic acids such as zinc stearate or calcium stearate; fatty acids such as stearic acid, oleic acid, or erucic acid; fatty amides such as stearamide, oleamide, erucamide, or N,N′-ethylene bis-stearamide; polyethylene wax; oxidized polyethylene wax; polymers of ethylene oxide; copolymers of ethylene oxide and propylene oxide; vegetable waxes; petroleum waxes; non-ionic surfactants; silicone fluids and polysiloxanes.

The antioxidants may comprise hindered phenols such as tetrakis[methylene(3,5-di-tert-butyl-4-hydroxyhydro-cinnamate)]methane; bis[(beta-(3,5-ditert-butyl-4-hydroxybenzyl) methylcarboxyethyl)]-sulphide, 4,4′-thiobis(2-methyl-6-tert-butylphenol), 4,4′-thiobis(2-tert-butyl-5-methylphenol), 2,2′-thiobis(4-methyl-6-tert-butylphenol), and thiodiethylene bis(3,5-di-tert-butyl-4-hydroxy)-hydrocinnamate; phosphites and phosphonites such as tris(2,4-di-tert-butylphenyl)phosphite and di-tert-butylphenyl-phosphonite; thio compounds such as dilaurylthiodipropionate, dimyristylthiodipropionate, and distearylthiodipropionate; various siloxanes; polymerized 2,2,4-trimethyl-1,2-dihydroquinoline, n,n′-bis(1,4-dimethylpentyl-p-phenylenediamine), alkylated diphenylamines, 4,4′-bis(alpha, alpha-dimethylbenzyl)diphenylamine, diphenyl-p-phenylenediamine, mixed di-aryl-p-phenylenediamines, and other hindered amine anti-degradants or stabilizers.

### Compounding and Coated Conductor Formation

The components of the polymeric composition can be added to a batch or continuous mixer for melt blending to form a melt-blended composition. The components can be added in any order or first preparing one or more masterbatches for blending with the other components. The melt blending may be conducted at a temperature above the melting point of the highest melting polymer. The melt-blended composition is then delivered to an extruder or an injection-molding machine or passed through a die for shaping into the desired article, or converted to pellets, tape, strip or film or some other form for storage or to prepare the material for feeding to a next shaping or processing step. Optionally, if shaped into pellets or some similar configuration, then the pellets, etc. can be coated with an anti-block agent to facilitate handling while in storage.

Examples of compounding equipment used include internal batch mixers, such as a BANBURY™ or BOLLING™ internal mixer. Alternatively, continuous single, or twin screw, mixers can be used, such as FARRELL™ continuous mixer, a WERNER™ and PFLEIDERER™ twin screw mixer, or a BUSS™ kneading continuous extruder. The type of mixer utilized, and the operating conditions of the mixer, will affect properties of the composition such as viscosity, volume resistivity, and extruded surface smoothness.

A coated conductor may be made from the polymeric composition. The coated conductor includes a conductor and a coating. The coating including the polymeric composition. The polymeric composition is at least partially disposed around the conductor to produce the coated conductor. The conductor may comprise a conductive metal or an optically transparent structure.

The process for producing a coated conductor includes mixing and heating the polymeric composition to at least the melting temperature of the polymeric components in an extruder to form a polymeric melt blend, and then coating the polymeric melt blend onto the conductor. The term “onto” includes direct contact or indirect contact between the polymeric melt blend and the conductor. The polymeric melt blend is in an extrudable state.

The polymeric composition is disposed around on and/or around the conductor to form a coating. The coating may be one or more inner layers such as an insulating layer. The coating may wholly or partially cover or otherwise surround or encase the conductor. The coating may be the sole component surrounding the conductor. Alternatively, the coating may be one layer of a multilayer jacket or sheath encasing the conductor. The coating may directly contact the conductor. The coating may directly contact an insulation layer surrounding the conductor.

### EXAMPLES

### Materials

The following materials are employed in the Examples, below.

HDPE is a high-density polyethylene (HDPE) comprised of an ethylene/octene copolymer and having a density of 0.9450 g/cc and a melt index of 0.80 g/10 min, which is available from The Dow Chemical Company, Midland, MI, USA.

LLDPE is a linear low-density polyethylene having a density of 0.920 g/cc, a melt flow index of 0.55 to 0.75 g/10 min. and is available from The Dow Chemical Company, Midland, MI, USA.

AO is a sterically hindered phenolic antioxidant having the chemical name pentaerythritol tetrakis(3-(3,5-di-tert-butyl-4-hydroxyphenyl)propionate), and is commercially available as IRGANOX™ from BASF, Ludwigshafen, Germany.

UVA1 is an ultraviolet light absorber with the chemical composition hydroxyphenyl triazine and commercially available as TINUVIN™ 1577 from BASF, Ludwigshafen, Germany.

UVA2 is an ultraviolet light absorber with the chemical composition 2-(2′-Hydroxy-3′-tert-butyl-5′-methylphenyl)-5-chlorobenzortriazole (CAS #3846-71-7) and commercially available as TINUVIN™ 326 from BASF, Ludwigshafen, Germany.

HALS1 is a hindered amine light stabilizer (CAS #70624-18-9) having the chemical name poly[[6-[(1,1,3,3-tetramethylbutyl)amino]-1,3,5-triazine-2,4-diyl][(2,2,6,6-tetramethyl-4-piperidinyl)imino]-1,6 hexanediyl[(2,2,6,6-tetramethyl-4-piperidinyl)imino]]), and is commercially available as CHIMASSORB™ 944 from BASF, Ludwigshafen, Germany.

HALS2 is an oligomeric hindered amine light stabilizer having the chemical composition of poly(4-hydroxy-2,2,6,6-tetramethyl-1-piperidineethanol-alt-1,4-butanedioic acid) (CAS #65447-77-0) and is commercially available as TINUVIN™ 622 from BASF, Ludwigshafen, Germany.

DPE is diphenyl ethylene having a CAS number of 530-48-3 and is commercially available from Tokyo Chemical Industry, Tokyo Japan.

AMSD is alpha-methyl styrene dimer having a CAS number of 6362-80-7 and is commercially available from Tokyo Chemical Industry, Tokyo Japan.

### Sample Preparation

Samples were prepared by compounding the HDPE and the LDPE in a BRABENDER™ mixer at 150° C. The rotor speed of the mixer was set to 10 revolutions per minute (“RPM”). The components other than the HDPE and LLDPE were fed into the mixer. The rotor speed was increased to 50 RPM and the samples were mixed for an additional 5 minutes. The samples were then cooled and cut into small pieces.

40 grams of the small pieces were sandwiched between two biaxially-oriented polyethylene terephthalate (i.e., Mylar) sheets and put into a mold with size of 100 millimeters (“mm”)×200 mm×2 mm. The mold was placed in a KT-201-A hot press machine from Shanghai Great Instrument Co. Ltd and preheated at 170° C. for 10 minutes. The mold was vented 8 times. Then the mold was held at 170° C. and 10 mega pascals (“MPa”) as measured by the hot press machine for another 5 minutes. Next the mold was cooled to room temperature using internal water cooling within 5 minutes at 10 MPa to form plaques.

The plaques were cut into 5A dogbones according to ISO 527-2. The 5A dogbones were placed in a QUV test chamber with fluorescent UVA-340 lamps. The exposure cycle consisted of a light cycle of 20 hours followed by a dark period of 4 hours where water vapor condensed to form water droplets over test specimens. In the light cycle, the controlled output irradiance was 0.7 w/m²*nm at 340 nm. The uninsulated black panel temperature (“BPT”) was 70±3 degree C. with the light on and 55±3 degree C. with light off. The relative humidity was 70±10% during the light cycle and greater than 95% during the dark cycle (i.e. water vapor condensation). The air temperature was uncontrolled during the entire operation. Samples, each with at least four replicates, were aged for 1000 hours (a total of 115 MVIJ/m² broadband irradiance derived from the integral of spectral irradiance from 295 nm to 400 nm) or 2000 hours respectively (a total of 230 MJ/m²).

### Test Methods

Maximum tensile strength and tensile elongation at break of the samples was performed in accordance with ASTM D638 on a 5565 tensile testing machine from Instron Calibration Lab at a speed of 50 mm/minute.

### Results

Table 1 provides the composition as well as mechanical properties such as maximum tensile strength (“TS”), the tensile elongation at break (“TE”), max tensile strength retention (“TS Retention”) and tensile elongation at break retention (“TE Retention”) for comparative example (“CE”) 1-3 and inventive examples (“IE”) 1-6 for different periods of accelerated UV aging. Tensile strength is reported in Mega Pascals (“MPa”). One standard deviation is reported for the TS and TE values. TS Retention values are calculated by dividing the 1000 hour or 2000 hour TS value by the initial TS value and multiplying by 100. TE Retention values are calculated by dividing the 1000 hour or 2000 hour TE value by the initial TE value and multiplying by 100. To be considered a passing example, the example must have exhibited a 2000 hour TS Retained value of 50% or greater and a 2000 hour TE Retained of 75% or greater. The 75% TS Retained and TE Retained values were chosen based on the UV aging standard ASTM D1248 that requires 50% TS Retained and TE Retained values at 4000 hours of similar UV exposure intensity.

TABLE 1

| | Component | | | | | | | | | |
|---|---|---|---|---|---|---|---|---|---|---|
| | (wt %) | CE1 | CE2 | CE3 | IE1 | IE2 | IE3 | IE4 | IE5 | IE6 |
| Composition | HDPE | 87.71 | 87.53 | 87.18 | 87.05 | 86.93 | 86.74 | 86.52 | 86.74 | 86.52 |
| | LLDPE | 11.89 | 11.87 | 11.82 | 11.80 | 11.78 | 11.76 | 11.73 | 11.76 | 11.73 |
| | DPE | — | — | — | 0.15 | 0.29 | 0.50 | 0.75 | 0.50 | — |
| | AMSD | — | — | — | — | — | — | — | — | 0.75 |
| | AO | 0.20 | — | 0.20 | 0.20 | 0.20 | 0.20 | 0.20 | 0.20 | 0.20 |
| | UVA1 | 0.20 | — | 0.20 | 0.20 | 0.20 | 0.20 | 0.20 | — | 0.20 |
| | UVA2 | — | — | — | — | — | — | — | 0.20 | — |
| | HALS1 | — | 0.30 | 0.30 | 0.30 | 0.30 | 0.30 | 0.30 | 0.30 | 0.30 |
| | HALS2 | — | 0.30 | 0.30 | 0.30 | 0.30 | 0.30 | 0.30 | 0.30 | 0.30 |

Results

| | | | | | | | | | | |
|---|---|---|---|---|---|---|---|---|---|---|
| Initial | TE (%) | 560 ± 14 | 607 ± 1 | 732 ± 36 | 677 ± 24 | 614 ± 9 | 647 ± 22 | 653 ± 44 | 642 ± 17 | 690 ± 43 |
| | TS (MPa) | 23 ± 0.4 | 24 ± 0.5 | 26 ± 0.1 | 23 ± 0.3 | 24 ± 0.4 | 22 ± 0.3 | 21 ± 0.4 | 22 ± 0.4 | 22 ± 0.1 |
| 1000 hrs | TE (%) | 54 ± 3 | 65 ± 77 | 630 ± 28 | — | 713 ± 54 | — | — | — | — |
| | TS (MPa) | 23 ± 0.2 | 24 ± 0.7 | 25 ± 0.2 | — | 25 ± 0.3 | — | — | — | — |
| | TE retention (%) | 10 | 11 | 86 | — | 116 | — | — | — | — |
| | TS retention (%) | 100 | 100 | 96 | — | 104 | — | — | — | — |
| 2000 hrs | TE (%) | — | — | 441 ± 253 | 768 ± 17 | 673 ± 41 | 725 ± 29 | 677 ± 132 | 681 ± 52 | 697 ± 112 |
| | TS (MPa) | — | — | 25 ± 1.1 | 24 ± 0.3 | 24 ± 0.3 | 24 ± 0.5 | 26 ± 0.3 | 24 ± 0.7 | 24 ± 0.3 |
| | TE retention (%) | — | — | 60 | 113 | 109 | 112 | 103 | 106 | 101 |
| | TS retention (%) | — | — | 96 | 104 | 100 | 109 | 123 | 109 | 109 |

As can be seen from Table 1, both CE1 and CE2 failed to maintain a TE Retention value of 75% or greater after 1000 hours of testing and as such were not tested for 2000 hours of exposure. CE3 was able to achieved both TS Retention and TE retention values of greater than 75% for 1000 hours of aging, but failed to maintain 75% TE Retention after 2000 hours of UV aging. IE1 demonstrates that the inclusion of as little as 0.15 wt % addition of diphenyl ethylene allows the composition to maintain greater than 75% TE Retention and TS Retention at 2000 hours. IE2-IE5 demonstrate that the addition of diphenyl ethylene is effective over a range of concentrations and even compatible with different UV absorbers. IE6 demonstrates that alpha-methyl styrene dimer is also able to maintain greater than 75% TE Retention and TS Retention at 2000 hours. It is believed that because polymeric compositions comprising diphenyl ethylene and alpha-methyl styrene dimer are able to exhibit greater than 75% TE Retention and TS Retention at 2000 hours, similar polymeric compositions would be able to retain greater than 50% TE Retention and TS Retention 4000 hour as required by ASTM D1248.

1. A polymeric composition comprising:
an ethylene-based polymer; and
a free radical scavenger having structure (I), 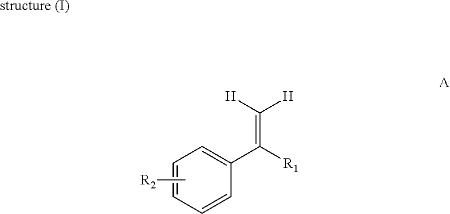
wherein, R₁ and R₂ are independently linear, or branch form alkyl, alkenyl, phenyl or aryl group moieties with or without substituents and each of R₁ and R₂ have a carbon number from 1 to 100,
further wherein the polymeric composition is thermoplastic.

2. The polymeric composition of claim 1, wherein the polymeric composition is free of carbon black.

3. The polymeric composition of claim 2, further comprising
a colorant.

4. The polymeric composition of claim 1, wherein the ethylene-based polymer comprises a linear low-density polyethylene having a density of 0.917 g/cc to 0.926 g/cc as measured according to ASTM D792 and a high-density polyethylene having a density of 0.940 g/cc to 0.970 g/cc as measured according to ASTM D792.

5. The polymeric composition of claim 4, wherein the polymeric composition comprises 80 wt % to 95 wt % high-density polyethylene based on the total weight of the polymeric composition.

6. The polymeric composition of claim 5, wherein the polymeric composition comprises 5 wt % to 20 wt % of the linear low-density polyethylene based on the total weight of the polymeric composition.

7. The polymeric composition of claim 1, wherein the free radical scavenger comprises alpha-methyl styrene dimer.

8. The polymeric composition of claim 1, wherein the free radical scavenger comprises diphenyl ethylene.

9. The polymeric composition of claim 1, wherein the polymeric composition comprises from 0.1 wt % to 1.0 wt % of the free radical scavenger based on a total weight of the polymeric composition.

10. A coated conductor comprising:
a conductor; and
the polymeric composition of claim 1 disposed at least partially around the conductor.
